(19) United States
(12) Patent Application Publication
(10) Pub. No.: US 2020/0097975 A1
(43) Pub. Date: Mar. 26, 2020

(54) METHODS AND SYSTEMS FOR SCREENING ELECTRONIC MONEY TRANSFER TRANSACTIONS

(71) Applicant: MASTERCARD INTERNATIONAL INCORPORATED, Purchase, NY (US)

(72) Inventors: DEBORAH KIMBERG, Dallas, TX (US); Shawn Eric Hagmeier, St. Peters, MO (US); Derek Ryan Reed, O'Fallon, MO (US)

(21) Appl. No.: 16/696,726

(22) Filed: Nov. 26, 2019

Related U.S. Application Data
(63) Continuation of application No. 14/479,610, filed on Sep. 8, 2014, now abandoned.
(60) Provisional application No. 61/879,463, filed on Sep. 18, 2013.

(51) Int. Cl. G06Q 20/40

(52) U.S. Cl. CPC G06Q 20/4016

(57) ABSTRACT

A computer-implemented method for processing a real-time money transfer with a screening payment network having a screening module communicatively coupled to a server computing device is provided. The method includes receiving a request to transfer funds from a payor account associated with an originating institution to a payee account associated with a receiving institution. The request includes money transfer data indicative of a payor's identifying information. The method also includes determining a sanction score based at least in part on the money transfer data, the sanction score indicative of the likelihood that the payor is on at least one sanctioned entity list. The method also includes transmitting the money transfer data and the sanction score to the receiving institution, and transmitting a response message to the originating institution, the response message indicating whether the receiving institution authorizes or denies the request to transfer the funds.

### CROSS REFERENCE TO RELATED APPLICATIONS

This application claims the benefit of U.S. Provisional Patent Application No. 61/879,463 filed Sep. 18, 2013, which is hereby incorporated by reference in its entirety.

### BACKGROUND OF THE DISCLOSURE

This disclosure relates generally to processing electronic money transfer transactions and, more particularly, to network-based methods and systems for screening electronic money transfer transactions initiated by a payor and made over a payment network.

In today's business world, a payor, i.e., a person that transmits funds, may wish to transfer funds to a payee, i.e., a person who receives funds. For example, a parent may wish to transfer funds to a child for living or other expenses. In another example, a business, such as an insurance company, may wish to transfer money to its customers, such as for insurance policy claims. In some known systems, a payor may write a paper check to the payee who then deposits the check at a local bank. However, paper checks require physical delivery as well as printing and/or mailing costs. In other known systems, funds may be transferred electronically from an account associated with the payor to an account associated with the payee. The electronically transferred funds can be processed quickly to allow the payee to access the transferred funds without requiring physical delivery of a paper check.

However, because of the ease with which known electronic systems can transfer funds, both domestically and internationally, criminal organizations have attempted to use them to launder money. More specifically, funds acquired in criminal activities may be transferred using at least some known systems to place the illegally obtained funds back into the market. To prevent the laundering of money and facilitate tracing electronically transferred funds, the U.S. and other countries have implemented anti-money laundering laws that require institutions that transfer and/or receive funds to collect identification, generate reports, and/or otherwise monitor money transfer transactions. More specifically, originating institutions that transfer funds and receiving institutions that receive transferred funds are required to monitor suspicious activities, high value transactions, and transfers to specific individuals or entities.

To comply with current anti-money laundering laws, known electronic money transfer systems enable an originating institution to screen money transfers prior to setting up a money transfer by requesting a payor be screened against a list of sanctioned entities. In such known systems, the originating institution transmits payor information to the system and receives a transaction identifier, a score indicative of the likelihood the payor is on the list of sanctioned entities, and a recommendation of whether the money transfer should be approved. The originating institution then sets up the money transfer, and includes the transaction identifier in the message. Therefore, currently known systems are inefficient and cannot be performed in real-time because they require at least two separate transactions for each money transfer transaction, a screening transaction and a money transfer transaction. Furthermore, screening for checks, wire transfers, and other payment transactions is generally performed in batches that do not facilitate real-time payment transactions.

Accordingly, a quicker and more efficient process for screening and processing money transfer transactions is needed.

### BRIEF DESCRIPTION OF THE DISCLOSURE

In one aspect, a computer-implemented method for processing a money transfer with a screening payment network having a screening module communicatively coupled to a server computing device is provided. The method includes receiving a request to transfer funds from a payor account associated with an originating institution to a payee account associated with a receiving institution. The request includes money transfer data indicative of a payor's identifying information. The method also includes determining a sanction score based at least in part on the money transfer data, the sanction score indicative of the likelihood that the payor is on at least one sanctioned entity list. The method also includes transmitting the money transfer data and the sanction score to the receiving institution, and transmitting a response message to the originating institution, the response message indicating whether the receiving institution authorizes or denies the request to transfer the funds.

In another aspect, a screening payment network for processing a money transfer transaction initiated by a payor is provided. The screening payment network includes a server computing device including a memory and a processor coupled to the memory and a screening module coupled to the server computing device. The screening module is configured to receive a request to transfer funds from a payor account associated with an originating institution to a payee account associated with a receiving institution, the request including money transfer data indicative of at least one of a payor's identifying information, a payment amount, and a payee account identifier. The screening module is also configured to determine a sanction score based at least in part on the money transfer data, the sanction score indicative of the likelihood that the payor is on at least one sanctioned entity list. The screening module is also configured to transmit the money transfer data and the sanction score to the receiving institution, and transmit a response message to the originating institution, the response message indicating whether the receiving institution authorizes or denies the request to transfer the funds.

In still another aspect, a computer readable medium is provided. The computer-readable medium having computer-executable instructions for processing a money transfer transaction embodied thereon, wherein, when executed by at least one processor, the computer-executable instructions cause the at least one processor to receive a request to transfer funds from a payor account associated with an originating institution to a payee account associated with a receiving institution, the request including money transfer data indicative of at least one of a payor's identifying information, a payment amount, and a payee account identifier. The computer-executable instructions also cause the processor to determine a sanction score based at least in part on the money transfer data, the sanction score indicative of the likelihood that a payor is on at least one sanctioned entity list. The computer-executable instructions also cause the processor to transmit the money transfer data and the sanction score to the receiving institution, and transmit a response message to the originating institution, the response message indicating whether the receiving institution authorizes or denies the request to transfer the funds.

### BRIEF DESCRIPTION OF THE DRAWINGS

FIG. 1 is a schematic diagram illustrating an exemplary multi-party payment card system for enabling ordinary payment-by-card transactions in which merchants and card issuers do not necessarily have a one-to-one relationship.

FIG. 2 is a schematic diagram illustrating an exemplary multi-party payment system for enabling ordinary money transfer transactions.

FIG. 3 is a simplified block diagram of an exemplary screening payment network having a screening module in accordance with one embodiment of the present disclosure.

FIG. 4 is an expanded block diagram of an exemplary embodiment of a server architecture of the payment network shown in FIG. 3.

FIG. 5 illustrates an exemplary configuration of a payor computing device operated by a payor such as the computing devices shown in FIGS. 3 and 4.

FIG. 6 illustrates an exemplary configuration of a server computing device such as the server system shown in FIGS. 3 and 4.

FIG. 7 is a simplified data flow block diagram of a money transfer being processed by the screening payment network shown in FIG. 3 in accordance with one embodiment of the present disclosure.

FIG. 8 is a flowchart showing a money transfer being processed by the screening payment network shown in FIG. 3.

### DETAILED DESCRIPTION OF THE DISCLOSURE

Embodiments of the methods and systems described herein include a payment network having a screening module (referred to herein collectively as the “screening payment network”) that enables the system to offer a near real-time money transfer service to at least one of payors, originating institutions, and receiving institutions. As used herein, real-time refers to outcomes occurring at a substantially short period after a change in the inputs affecting the outcome, for example, receiving transaction data, screening the transaction and generating a score available for transmission or further processing. The period is the amount of time between each iteration of a regularly repeated task or between one task and another. The time period is a result of design parameters of the real-time system that may be selected based on the importance of the outcome and/or the capability of the system implementing processing of the inputs to generate the outcome. Additionally, events occurring in real-time occur without substantial intentional delay. In one embodiment, a payor, such as an insurance company, governmental entity, business entity, individual, and/or any other entity that transmits a payment, registers with an originating institution and provides money transfer data to the originating institution as part of a request to transfer funds to a payee (e.g., an insured, a constituent, a client, and/or any other entity that receives a payment). The screening payment network enables the originating institution, also referred to as an acquirer bank, to screen a payor and perform a money transfer transaction as part of a single transaction over the screening payment network. More specifically, the screening payment network receives an authorization request including money transfer data before, or substantially simultaneously with, determining a sanction score for the payor based on the money transfer data. The sanction score indicates the likelihood the payor is prohibited from performing payment transactions, such as money transfers. Further, in the exemplary embodiment, the screening payment network substantially simultaneously transmits the authorization request and the sanction score to the receiving institution to facilitate near real-time processing of money transfer transactions. As described herein, simultaneously means occurring in close temporal proximity without intentional delay.

In the example embodiment, when a payor requests a money transfer transaction be performed, the originating institution collects money transfer data from the payor. The money transfer data includes payor identifying information, e.g., a payor's first and last name, a payor's address, a payor's date of birth, and/or any other information associated with the payor. Money transfer data also includes, for example, a payee account identifier, such as a Primary Account Number (PAN) and/or a Mobile Subscriber Integrated Services Digital Network-Number (MSISDN) that indicate a payee account to which funds are to be transferred, a payment amount, and/or any other information related to the money transfer transaction. Further, in the example embodiment, the originating institution authenticates the payor, such as by collecting physical identification and/or confirming a username and password entered over a web portal, and debits funds from the payor's account. Once authenticated, the originating institution transmits the collected information to the screening payment network as part of a money transfer request.

In the example embodiment, the screening payment network includes a screening module that receives the money transfer data and determines a sanction score indicative of the likelihood that the payor is on a sanctioned entity list, is engaged in money laundering activity, and/or is otherwise prohibited from performing money transfer transactions. For example, the screening module may determine the sanction score by comparing the payor's identifying information, including at least one of the payor's first and last name, city, country, and date-of-birth with corresponding identifying information on a sanctioned entity list, such as the Specially Designated Nationals (SDN) list issued by the U.S. Treasury. A sanctioned entity list is a list of entities including individuals, businesses, governments, etc., that are prohibited from performing payment transactions. Sanctioned entity lists are typically provided by a government agency, e.g., the FBI, CIA, and/or other agencies, and designate the entities with whom payment transactions are prohibited, e.g., money launderers, terrorist groups, criminal organizations, embargoed countries, etc. In addition, many countries have at least one sanctioned entity list associated with that particular country that may contain different entities. In at least some embodiments, the screening module may determine the sanction score by comparing the received data with a plurality of sanctioned entity lists, for example, any combination of the sanctioned entity lists for the originating institution's country, the payor's country, the payee's country, and the receiving institution's country. In at least one embodiment, the screening payment network generates an intermediate sanction score for each sanctioned entity list that is compared with the payor's identifying information, and determines the sanction score by selecting the highest intermediate sanction score. The sanction score may be determined by more than a direct comparison, and may factor in common alterations and/or spellings in names and addresses.

In the example embodiment, the screening payment network screens the sender and inserts the sanction score and the money transfer data into an authorization request, and transmits the authorization request to the receiving institution. In other embodiments, the screening payment network substantially simultaneously screens the sender and transmits the sanction score and the authorization request to the receiving institution. Further, in the exemplary embodiment, the screening payment network also transmits the sanction score back to the originating institution. The receiving institution analyzes the authorization request including the sanction score, and transmits an authorization message indicating one of an authorization confirmation and an authorization denial to the screening payment network based at least in part on the sanction score.

The screening payment network routes the authorization message to the originating institution. The originating institution informs the payor of the authorization or the denial, and, if authorized, transfers the payment amount from the payor account to the payee account. More specifically, the payee receives an electronic payment either by the funds being transferred directly to the payee account, to a retail location for payee pickup, and/or being transferred in real-time to a prepaid credit or debit card that the payee can use immediately.

In at least some embodiments, the screening module may further determine whether to deny or authorize the money transfer transaction based on comparing the sanction score with a predefined threshold range. For example, if the sanction score is a number 1-100 indicating a percentage likelihood of the payor being on one of the sanctioned entity lists, the originating institution and/or receiving institution may provide a predefined threshold range, e.g., 90-100, for which the money transfer transaction is to be denied. In such embodiments, money transfer transactions that are not within the threshold range are rejected, an authorization denial message is returned to the originating institution, and an advice message is provided to the receiving institution. The advice message informs the receiving institution at least that a transaction was denied, and may include details of the transaction. In other implementations, screening module may determine whether to deny and/or authorize the money transfer transaction based on comparing the sanction score with a plurality of predefined threshold ranges. For example, if the sanction score indicates a percentage likelihood of the payor being on one of the sanctioned entity lists as described above, the originating institution and/or the receiving institution may define a predefined threshold range for which money transfer transactions are to be authorized, e.g., 1-80, a predefined threshold range for which money transfer transactions are to be denied, e.g., 95-100, and/or a predefined threshold range for which a request is set to a pending status awaiting further authorization, e.g. 80-95. In one implementation, requests set to a pending status undergo a compliance review to determine if the transaction should be authorized or denied. The numbers and ranges defined above are merely exemplary, and any value may be chosen for any of the above parameters.

Also in the exemplary embodiment, the screening payment network records a plurality of suspicious money transfer transactions having a sanction score within a predefined threshold range, and generates a report relating to the plurality of suspicious money transfer transactions. For example, the screening payment network records the payor identifying information and sanctioned entity list used in determining the sanction score for each money transfer transaction with a sanction score within a predefined threshold range, e.g., 80-100. Each of the recorded money transfer transactions is then included in a report provided to the receiving institution. The report includes the payor's identifying information, potential matches with the sanctioned entity list, and the corresponding sanctioned entity lists used in the screening process.

Accordingly, the screening payment network enables a payor, such as a business entity, to electronically transfer funds to a payee over the screening payment network from a payor account to a payee account or a prepaid payment card associated with the payee. Moreover, the screening payment network enables an originating institution to quickly transfer funds in near real-time without incurring the time delays associated with issuing separate screening and money transfer transaction requests. In addition, the screening payment network enables a receiving institution to quickly analyze a sanction score associated with a payor, and to authorize the money transfer transaction in near real-time.

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure. The disclosure is described as applied to an exemplary embodiment, namely, systems and methods of screening payor identifying information through a payment network for money transfer transactions. However, it is contemplated that this disclosure has general application to computing systems in industrial, commercial, and residential applications.

Although the screening payment network may be described herein in the context of use for preventing money laundering, it is not limited to this particular use. Accordingly, the screening payment network may be used in other embodiments, including any other purpose that includes transferring funds between entities.

As used herein, an element or step recited in the singular and preceded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

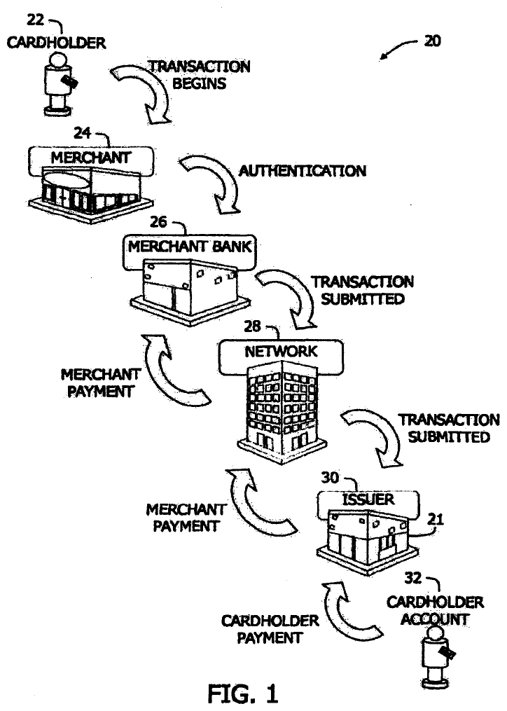

FIG. 1 is a schematic diagram illustrating an exemplary multi-party payment system 20 for enabling ordinary payment card transactions. The present disclosure relates to a payment network 28, such as a card payment network using the MasterCard® payment system. The MasterCard® payment system is a proprietary communications standard promulgated by MasterCard International Incorporated® for the exchange of financial transaction data between financial institutions that are members of MasterCard International Incorporated®. (MasterCard is a registered trademark of MasterCard International Incorporated located in Purchase, N.Y.).

In a typical payment card system, a financial institution such as an issuer 30 issues a payment card, such as a credit card, a debit card, and/or a pre-paid card to a cardholder 22, who uses the payment card to tender payment for a purchase from a merchant 24. To accept payment with the payment card, merchant 24 must normally establish an account with a financial institution that is part of the financial payment system. This financial institution is usually called the “merchant bank,” the “acquiring bank,” or the “acquirer bank.” When a cardholder 22 tenders payment for a purchase with a payment card (also known as a financial transaction card), merchant 24 requests authorization from merchant bank 26 for the amount of the purchase. The request may be performed over the telephone, but is usually performed through the use of a point-of-sale terminal, which reads the cardholder's account information from the magnetic stripe on the payment account card and communicates electronically with the transaction processing computers of merchant bank 26. Alternatively, merchant bank 26 may authorize a third party to perform transaction processing on its behalf. In this case, the point-of-sale terminal will be configured to communicate with the third party. Such a third party is usually called a “merchant processor” or an “acquiring processor.”

Using payment network 28, the computers of the merchant bank or the merchant processor will communicate with the computers of issuer 30 to determine whether the cardholder's account is in good standing and whether the purchase is covered by the cardholder's available credit line or account balance. Based on these determinations, the request for authorization will be declined or accepted. If the request is accepted, an authorization code is issued to merchant 24.

When a request for authorization is accepted, the available credit line or available balance of cardholder's account 32 is decreased. Normally, a charge is not posted immediately to a cardholder's account because bankcard associations, such as MasterCard International Incorporated®, have promulgated rules that do not allow a merchant to charge, or “capture,” a transaction until goods are shipped or services are delivered. When a merchant ships or delivers the goods or services, merchant 24 captures the transaction by, for example, appropriate data entry procedures on the point-of-sale terminal. If a cardholder cancels a transaction before it is captured, a “void” is generated. If a cardholder returns goods after the transaction has been captured, a “credit” is generated.

For debit card transactions, when a request for a PIN authorization is approved by the issuer, the cardholder's account 32 is decreased. Normally, a charge is posted immediately to cardholder's account 32. The bankcard association then transmits the approval to the acquiring processor for distribution of goods/services, or information or cash in the case of an ATM.

After a transaction is captured, the transaction is settled between merchant 24, merchant bank 26, and issuer 30. Settlement refers to the transfer of financial data or funds between the merchant's account, merchant bank 26, and issuer 30 related to the transaction. Usually, transactions are captured and accumulated into a “batch,” which is settled as a group.

Financial transaction cards or payment cards can refer to credit cards, debit cards, and prepaid cards. These cards can all be used as a method of payment for performing a transaction. As described herein, the term “financial transaction card” or “payment card” includes cards such as credit cards, debit cards, and prepaid cards, but also includes any other devices that may hold payment account information, such as mobile phones, personal digital assistants (PDAs), and key fobs.

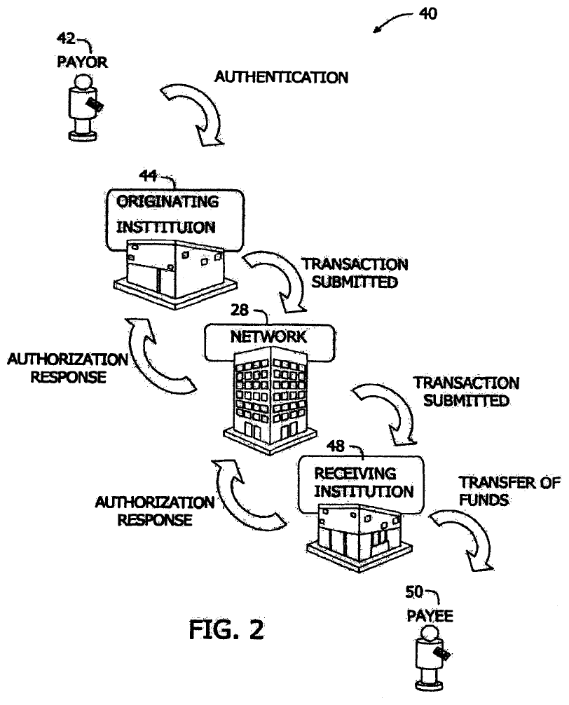

FIG. 2 is a schematic diagram of a multi-party payment system 40 for enabling ordinary money transfer transactions. In a typical payment system 40, a financial institution such as an originating institution 44 provides a website or brick and mortar location where a payor 42 may transfer funds to a payee 50. When payor 42 tenders a request to transfer money to originating institution 44, originating institution 44 requests authorization from receiving institution 48 for the amount of the purchase. The request may be performed over the telephone, but is usually performed through the use of computing devices at originating institution 44 that communicate electronically with the transaction processing computers of receiving institution 48 over a payment network 28.

Using payment network 28, the computers of originating institution 44, sometimes referred to as an acquirer bank, communicate with the computers of receiving institution 48 to determine whether the payor's account is in good standing and whether the purchase is covered by the payor's available account balance. Based in part on these determinations, the request for authorization will be declined or accepted. If the request is accepted, an authorization code is issued to originating institution 44.

When a request for authorization is accepted, the available credit line or available balance of payor's account is decreased and the transaction is settled between payee 50, originating institution 44, and receiving institution 48. Settlement refers to the transfer of financial data or funds between the payee's 50 account, originating institution 44, and receiving institution 48 related to the transaction. Usually, transactions are captured and accumulated into a “batch,” which is settled as a group.

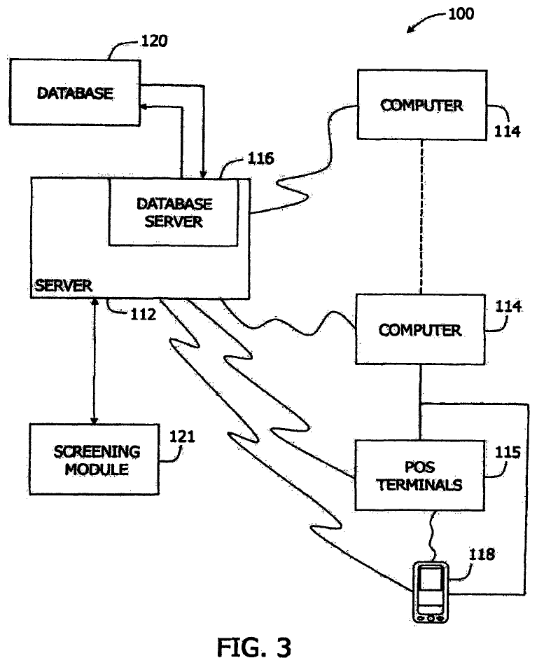

FIG. 3 is a simplified block diagram of an exemplary screening payment network 100 having a screening module and offering a screening service in accordance with one embodiment of the present disclosure. Network 100 is a payment system which can be utilized by payors 42 (shown in FIG. 2) as part of a process of initiating an authorization request and performing a money transfer transaction as described below. In addition, network 100 is a payment has a screening module, which enables payor 42 (e.g., merchant, business entity, individual etc.) to be screened by the system and initiate an electronic money transfer to payee 50 (shown in FIG. 2) (e.g., customer, etc.) as described below.

More specifically, in the example embodiment, network 100 includes a server system 112, which is a type of computer system, and a plurality of client sub-systems (also referred to as client systems 114) connected to server system 112. In the example embodiment, client systems 114 are computing devices associated with originating institution 44 (shown in FIG. 2) and/or receiving institution 48 (shown in FIG. 2). In one embodiment, client systems 114 are computers including a web browser and a memory device, such that server system 112 is accessible to client systems 114 using the Internet. Client systems 114 are interconnected to the Internet through many interfaces including a network, such as a local area network (LAN) or a wide area network (WAN), dial-in-connections, cable modems, and special high-speed ISDN lines. Client systems 114 could be any device capable of interconnecting to the Internet including a web-based phone, personal digital assistant (PDA), or other web-based connectable equipment.

Network 100 also includes point-of-sale (POS) terminals 115, which are connected to client systems 114 and may be connected to server system 112. POS terminals 115 are interconnected to the Internet through many interfaces including a network, such as a local area network (LAN) or a wide area network (WAN), dial-in-connections, cable modems, wireless modems, and special high-speed ISDN lines. POS terminals 115 could be any device capable of interconnecting to the Internet and including an input device capable of reading information from a cardholder's financial transaction card.

A database server 116 is connected to database 120, which contains information on a variety of matters, as described below in greater detail. In one embodiment, centralized database 120 is stored on server system 112 and can be accessed by payors 42 at one of client systems 114 by logging onto server system 112 through one of client systems 114. In an alternative embodiment, database 120 is stored remotely from server system 112 and may be non-centralized. Database 120 may store transaction data generated as part of sales activities and/or money transfers conducted over network 100 including data relating to merchants, account holders, payees, payors, originating institutions, receiving institutions, customers, and/or purchases. Database 120 may also store account data including at least one of a payor name, a payor address, an account number, and other account identifiers. Database 120 may also store payee data including a payee identifier that identifies each payee registered to use the payment network. Database 120 may also store instructions for settling transactions including merchant bank account information. Database 120 may also store PAN numbers or bank account numbers for various parties including merchants, customers, payees, and payors along with payment verification identifiers and other data necessary to implement the system and processes described herein.

In one embodiment, a screening module 121 is in communication with server system 112. Screening module 121 enables network 100 to offer the screening service, which enables payor 42 (shown in FIG. 2) to transfer funds electronically to payee 50 (shown in FIG. 2), and validate that payor 42 is not on a sanctioned entity list. Specifically, originating institution 44 uploads money transfer data to screening module 121. Screening module 121 determines a sanction score associated with the money transfer transaction by comparing the payor's identifying information to at least one sanctioned entity list. Screening module 121 then transmits the sanction score and money transfer data to receiving institution 48 as part of an authorization request. Screening module 121 receives an authorization message from receiving institution 48 indicating one of an authorization confirmation and an authorization denial, and routes the authorization message to originating institution 44. If the authorization message is an authorization confirmation a settlement process for transferring funds from the payor to the payee is performed. The funds are transferred as requested by the payor either to the payee account associated with the payee account identifier or to a prepaid payment card. In at least some embodiments, screening module 121 is integral with server system 112. In other embodiments, screening module 121 is a stand-alone module separate from server system 112.

Network 100 also includes at least one input device 118, which is configured to communicate with at least one of POS terminal 115, client systems 114 and server system 112. In the exemplary embodiment, input device 118 is associated with or controlled by a payor performing a money transfer transaction. Input device 118 is interconnected to the Internet through many interfaces including a network, such as a local area network (LAN) or a wide area network (WAN), dial-in-connections, cable modems, wireless modems, and special high-speed ISDN lines. Input device 118 could be any device capable of interconnecting to the Internet including a web-based phone, personal digital assistant (PDA), or other web-based connectable equipment. In one embodiment, input device 118 is configured to communicate with client system 114 using various outputs including, for example, Bluetooth communication, radio frequency communication, near field communication, network-based communication, and the like. More specifically, in one embodiment, input device 118 communicates with client system 114 through a website associated with client system 114.

In the example embodiment, one of client systems 114 may be associated with an acquirer bank or an originating institution 44; while another one of client systems 114 may be associated with an issuer or receiving institution; POS terminal 115 may be associated with a merchant or originating institution; input device may be associated with a payor or a payee; and server system 112 may be associated with screening payment network 100.

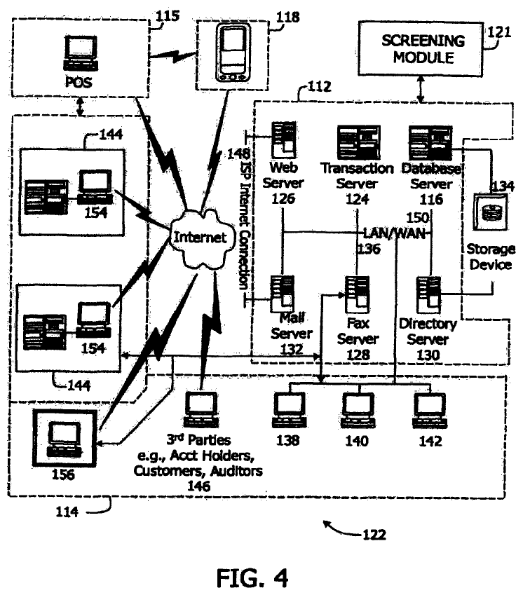

FIG. 4 is an expanded block diagram of an exemplary embodiment of a server architecture of payment network 122 having screening module 121 and offering a screening service in accordance with one embodiment of the present disclosure. Components in network 122, identical to components of network 100 (shown in FIG. 3), are identified in FIG. 4 using the same reference numerals as used in FIG. 3. Network 122 includes server system 112, client systems 114, POS terminals 115, and input devices 118. Server system 112 further includes database server 116, a transaction server 124, a web server 126, a fax server 128, a directory server 130, and a mail server 132. A storage device 134 is coupled to database server 116 and directory server 130. Servers 116, 124, 126, 128, 130, and 132 are coupled in a local area network (LAN) 136. In addition, a system administrator's workstation 138, a payor's workstation 140, and a supervisor's workstation 142 are coupled to LAN 136. Alternatively, workstations 138, 140, and 142 are coupled to LAN 136 using an Internet link or are connected through an Intranet.

Each workstation, 138, 140, and 142 is a personal computer having a web browser. Although the functions performed at the workstations typically are illustrated as being performed at respective workstations 138, 140, and 142, such functions can be performed at one of many personal computers coupled to LAN 136. Workstations 138, 140, and 142 are illustrated as being associated with separate functions only to facilitate an understanding of the different types of functions that can be performed by individuals having access to LAN 136.

Server system 112 is configured to be communicatively coupled to various individuals, including employees 144 and to third parties, e.g., account holders, customers, auditors, etc., 146 using an ISP Internet connection 148. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 150, local area network 136 could be used in place of WAN 150.

In the exemplary embodiment, any authorized individual having a workstation 154 can access network 122. At least one of the client systems includes a manager workstation 156 located at a remote location. Workstations 154 and 156 are personal computers having a web browser. Also, workstations 154 and 156 are configured to communicate with server system 112. Furthermore, fax server 128 communicates with remotely located client systems, including a client system 156 using a telephone link. Fax server 128 is configured to communicate with other client systems 138, 140, and 142 as well.

In the example embodiment, server system 112 is in communication with screening module 121. Screening module 121 enables network 122 to offer the screening service, which enables payor 42 (shown in FIG. 2) to transfer funds electronically to payee 50 (shown in FIG. 2), and validate that payor 42 is not on a sanctioned entity list.

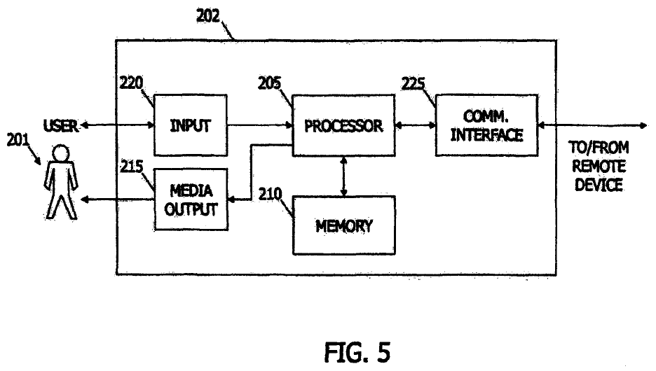

FIG. 5 illustrates an exemplary configuration of a user computing device 202 operated by a user 201, e.g., payor 42. User computing device 202 may include, but is not limited to, client systems 114, 138, 140, and 142, POS terminal 115, input device 118, workstation 154, and manager workstation 156 (shown in FIG. 3).

User computing device 202 includes a processor 205 for executing instructions. In some embodiments, executable instructions are stored in a memory area 210. Processor 205 may include one or more processing units (e.g., in a multi-core configuration). Memory 210 is any device allowing information such as executable instructions and/or other data to be stored and retrieved. Memory 210 may include one or more computer readable media.

User computing device 202 also includes at least one media output component 215 for presenting information to users 201. Media output component 215 is any component capable of conveying information to users 201. In some embodiments, media output component 215 includes an output adapter such as a video adapter and/or an audio adapter. An output adapter is operatively coupled to processor 205 and operatively couplable to an output device such as a display device (e.g., a liquid crystal display (LCD), organic light emitting diode (OLED) display, cathode ray tube (CRT), or “electronic ink” display) or an audio output device (e.g., a speaker or headphones).

In some embodiments, user computing device 202 includes an input device 220 for receiving input from users 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

User computing device 202 may also include a communication interface 225, which is communicatively couplable to a remote device such as server system 112. Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory 210 are, for example, computer readable instructions for providing a user interface to users 201 via media output component 215 and, optionally, receiving and processing input from input device 220. A user interface may include, among other possibilities, a web browser and client application. Web browsers enable cardholder's, such as users 201, to display and interact with media and other information typically embedded on a web page or a website from server system 112. A client application allows users 201 to interact with a server application from server system 112.

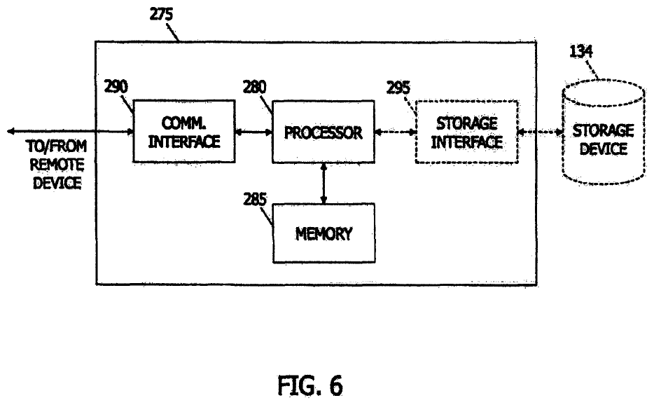

FIG. 6 illustrates an exemplary configuration of a server computing device 275 such as server system 112 (shown in FIGS. 3 and 4). Server computing device 275 may include, but is not limited to, database server 116, transaction server 124, web server 126, fax server 128, directory server 130, and mail server 132.

Server computing device 275 includes a processor 280 for executing instructions. Instructions may be stored in a memory area 285, for example. Processor 280 may include one or more processing units (e.g., in a multi-core configuration).

Processor 280 is operatively coupled to a communication interface 290 such that server computing device 275 is capable of communicating with a remote device such as user computing device 202 or another server computing device 275. For example, communication interface 290 may receive requests from client systems 114 or input device 118 via the Internet, as illustrated in FIGS. 2 and 3.

Processor 280 may also be operatively coupled to a storage device 134. Storage device 134 is any computer-operated hardware suitable for storing and/or retrieving data. In some embodiments, storage device 134 is integrated in server computing device 275. For example, server computing device 275 may include one or more hard disk drives as storage device 134. In other embodiments, storage device 134 is external to server computing device 275 and may be accessed by a plurality of server computer devices 275. For example, storage device 134 may include multiple storage units such as hard disks or solid state disks in a redundant array of inexpensive disks (RAID) configuration. Storage device 134 may include a storage area network (SAN) and/or a network attached storage (NAS) system.

In some embodiments, processor 280 is operatively coupled to storage device 134 via a storage interface 295. Storage interface 295 is any component capable of providing processor 280 with access to storage device 134. Storage interface 295 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 280 with access to storage device 134.

Memory 210 and 285 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

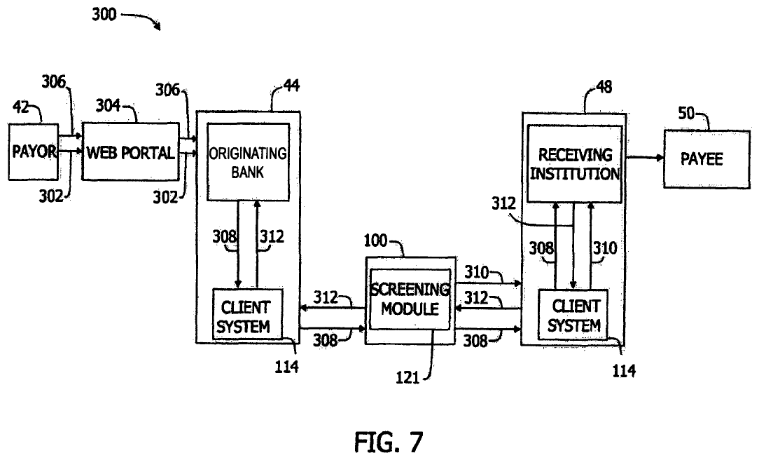

FIG. 7 is a simplified data flow block diagram 300 of a disbursement transaction being processed by screening payment network 100 (shown in FIGS. 3 and 4) in accordance with one embodiment of the present disclosure. Components in diagram 300 that are identical to components already identified in earlier figures are identified using the same reference numerals previously used.

In the example embodiment, payor 42 communicates a money transfer transaction request 302 through a web portal 304 associated with originating institution 44 or a service provider sponsored by originating institution 44. In various embodiments, originating institution 44 does not offer the screening service directly to the payor. A third party, such as, but not limited to Square™, PayPal™, or a company that offers disbursement services can offer the service and be sponsored by originating institution 44. In the example embodiment, money transfer transaction request 302 includes money transfer data including at least payor identifying information and a payee account identifier. In at least one embodiment, payor identifying information data includes at least one of the payor's name, payor's address, and payor's date-of-birth. In at least one other embodiment, payor 42 communicates money transfer transaction request 302 directly, for example, at a brick and mortar store of originating institution 44. Moreover, in the example embodiment, payor 42 submits identifying information 306, for example, a user name and password or a driver's license, to originating institution 44. Originating institution 44 receives money transfer transaction request 302 and identifying information 306, and authenticates identifying information 306. Originating institution 44 then transmits an authorization request message 308, including the money transfer data, to screening payment network 100 through client system 114.

Further, in the example embodiment, screening payment network 100 receives authorization request message 308 and routes the request to screening module 121. Screening module 121 processes authorization request message 308 and determines a sanction score 310 based on the money transfer data included with authorization request message 308. More specifically, screening module 121 compares the payor's identifying information with corresponding identifying information on at least one sanctioned entity list to determine sanction score 310. In the example embodiment, screening module 121 compares the payor's identifying information with a plurality of sanctioned entity lists, for example, the sanctioned entity list associated with the payor's country, the sanctioned entity list associated with the payee's country, the sanctioned entity list associated with the originating institution's country, and/or the sanctioned entity list associated with the receiving institution. Alternatively, screening module 121 may compare the payor's identifying information with any number of sanctioned entity lists that enables screening module 121 to determine a sanction score 310 as described herein. In at least one embodiment, screening module 121 generates an intermediate sanction score for each sanctioned entity list compared with the payor's identifying information, and determines sanction score 310 by selecting the highest intermediate sanction score.

Also in the example embodiment, screening module 121 transmits the authorization request message 308 and the sanction score 310 to receiving institution 48. In the example embodiment, sanction score 310 and authorization request message 308 are transmitted substantially simultaneously to receiving institution 48. For example, sanction score 310 may be inserted into authorization request message 308 and transmitted as a single message. In some embodiments, screening module 121 may transmit the sanction score 310 to originating institution 44 for tracking and/or verification.

In the example embodiment, upon receiving authorization request message 308 and sanction score 310, receiving institution 48 verifies the existence in good standing of an account associated with payee 50 and indicated by the payee account identifier. In the case where payee 50 has registered to receive money transfers via a prepaid card, receiving institution 48 verifies that receiving institution 48 is capable of issuing the requested prepaid card to payee 50. Receiving institution 48 further verifies sanction score 310 is within an acceptable predefined threshold range, e.g., 1-70.

After completing the verification process, receiving institution 48 transmits an authorization response message 312 to screening payment network 100, which in turn communicates authorization response message 312 to originating institution 44. In the example embodiment, authorization response message 312 is a confirmation message if sanction score 310 is within an acceptable predefined threshold range. If, however, receiving institution 48 determines sanction score 310 is not within the acceptable predefined range, e.g., 71-100, then authorization response message 312 is a denial message and the money transfer transaction is cancelled.

After receiving a confirming authorization response message 312, originating institution 44 transfers funds 314 from a payor account associated with originating institution 44 to the payee account associated with receiving institution, for example a pre-paid card. In one embodiment, the transferred funds 314 are determined by the payment amount indicated by the money transfer data.

Also in the exemplary embodiment, the screening module 121 records a plurality of suspicious money transfer transactions having sanction score 310 within a predefined threshold range, and generates a report relating to the plurality of suspicious money transfer transactions. For example, screening module 121 records the payor identifying information and sanctioned entity list used in determining the sanction score for each transaction with sanction score 310 within a predefined threshold range, e.g., 70-100. Screening module 121 provides the generated report to the receiving institution periodically.

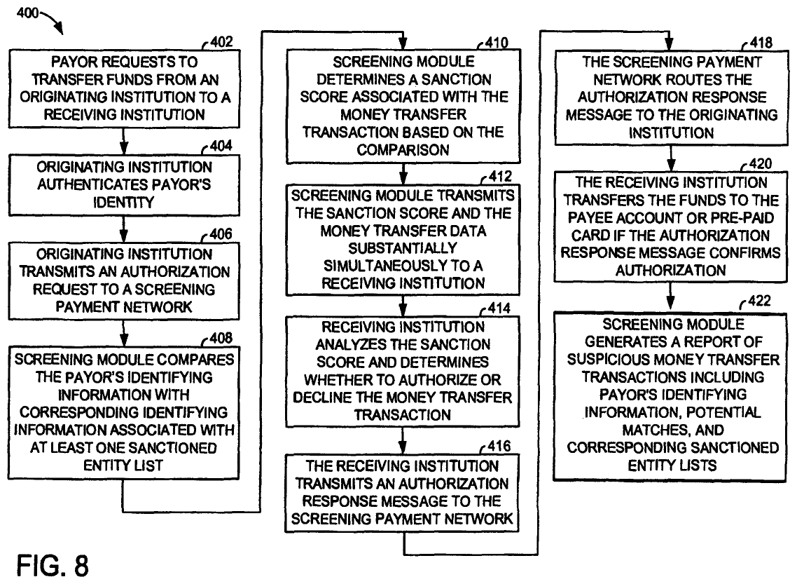

FIG. 8 is a flowchart 400 showing a money transfer transaction being processed by a screening payment network 100 (shown in FIG. 3). In the example embodiment, payor 42 (shown in FIG. 2) accesses a website and/or brick-and-mortar building associated with originating institution 44 or a service provider sponsored by originating institution 44 (shown in FIG. 2) and requests 402 to transfer funds to a payee.

Also, in the exemplary embodiment, originating institution 44 authenticates 404 payor 42 and transmits 406 an authorization request including money transaction data to screening payment network 100 having screening module 121. Screening module 121 processes the money transaction data and compares 408 the payor's identifying information with corresponding identifying information associated with at least one sanctioned entity list. Based on the results of the comparison, screening module 121 determines 410 sanction score 310 associated with the money transfer transaction, and transmits 412 sanction score 310 and the money transaction data to receiving institution 48. Receiving institution 48 analyzes 414 sanction score 310 and the money transaction data and transmits 416 an authorization response message to screening payment network 100. Screening payment network 100 routes 418 the authorization response message to originating institution 44. If the authorization response message is a confirmation message, originating institution 44 transfers 420 funds from a payor's account to a payee's account, e.g., a debit card associated with the payee issued by receiving institution 48. In the exemplary embodiment, screening module 121 records money transfer data for suspicious money transfer transactions having sanction score 310 above a predefined threshold level, and generates 422 a report for the plurality of suspicious money transfer transactions.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by processors 205, 280 including RAM memory, ROM memory, EPROM memory, EEPROM memory, and non-volatile RAM (NVRAM) memory. The above memory types are exemplary only, and are thus not limiting as to the types of memory usable for storage of a computer program.

As will be appreciated based on the foregoing specification, the above-described embodiments of the disclosure may be implemented using computer programming or engineering techniques including computer software, firmware, hardware or any combination or subset thereof, wherein the technical effect is (a) receiving, by the screening module, a request to transfer funds from a payor account associated with an originating institution, its service provider, or another card issuer to a payee account associated with a receiving institution, the request including money transfer data indicative of at least one of a payor's identifying information, a payment amount, and a payee account identifier; (b) determining a sanction score based at least in part on the money transfer data, the sanction score indicative of the likelihood that the payor is on at least one sanctioned entity list; (c) transmitting, by the screening module, the money transfer data and the sanction score to the receiving institution; and (d) transmitting a response message to the originating institution, the response message indicating whether the receiving institution authorizes or denies the request to transfer the funds. In various embodiments, the payor's account can be issued by originating institution 44, another bank, or the service provider sponsored by originating institution 44 may have a stored value account. The account does not have to reside at originating institution 44. The role of originating institution 44 is to originate the transaction on the network, not to hold the account.

Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The computer-readable media however, may not be a transitory signal. The article of manufacture containing the computer code may be made and/or used by executing the code directly from one medium, by copying the code from one medium to another medium, or by transmitting the code over a network.

This written description uses examples to describe the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1-24. (canceled)

25. A computer-implemented method for real-time screening of a money transfer over a payment network, wherein the payment network includes at least one processor coupled to a memory device, the at least one processor configured to route messages formatted in a proprietary communications standard promulgated by the payment network, said method comprising:
generating, by the at least one processor, an intermediate sanction score for each of one or more sanctioned entity lists, the one or more sanctioned entity lists stored in the memory device and each including information identifying one or more entities with whom payment transactions are prohibited by law;
assigning, by the at least one processor, the intermediate sanction score to each of the one or more sanctioned entity lists;
receiving, by the at least one processor, from an originating institution computing device registered with the payment network as an acquiring bank, an authorization request message formatted according the proprietary communications standard, the authorization request message including money transfer data including a payor's identifying information, a payment amount, and a payee account identifier;
routing, by the at least one processor, the authorization request message to a screening module executed by the at least one processor;
determining, by the screening module, a sanction score associated with the authorization request message, the sanction score based at least in part on i) the intermediate sanction score assigned to the one or more sanctioned entity lists and ii) the money transfer data;
modifying, by the screening module, the authorization request message by inserting the sanction score into the authorization request message;
transmitting, by the screening module, the modified authorization request message including the sanction score to a receiving institution, wherein the receiving institution is registered with the payment network as an issuer of a payee account associated with the payee account identifier;
receiving, in real-time by the at least one processor in response to transmitting the modified authorization request message, an authorization response message from the receiving institution, the authorization response message formatted according to the proprietary communications standard and indicating whether the receiving institution authorizes or denies transfer of the payment amount to the payee account based on the sanction score and an existence of the payee account in good standing at the receiving institution; and
transmitting, by the at least one processor, the authorization response message to the originating institution.

26. The method of claim 25 further comprising comparing the sanction score with at least one predefined threshold range set by one of the receiving institution and the originating institution.

27. The method of claim 26 further comprising processing a plurality of money transfer transactions and generating a report of a plurality of suspicious money transfers transactions having sanction scores within the predefined threshold range.

28. The method of claim 27, wherein the report includes at least one of the payor's identifying information, potential matches with the one or more sanctioned entity lists, and the corresponding one or more sanctioned entity lists used to determine the sanction score, for each of the plurality of suspicious money transfers.

29. The method of claim 25, wherein determining the sanction score comprises:
generating a plurality of intermediate sanction scores by comparing the payor's identifying information with a first set of sanctioned entity lists associated with a country's payor, a second set of sanctioned entity lists associated with a country of the originating institution, and a third set of sanctioned entity lists associated with a country of the receiving institution; and
selecting the highest intermediate sanction score as the sanction score.

30. The method of claim 25, wherein the request to transfer funds occurs before, or substantially simultaneously with, determining a sanction score.

31. The method of claim 25, wherein the payor's identifying information includes at least a payor name, a payor address, and a payor's date-of-birth.

32. A screening payment network for real-time screening of a money transfer over the screening payment network, wherein the screening payment network includes at least one processor coupled to a memory device, wherein the at least one processor is configured to route messages formatted in a proprietary communications standard promulgated by the screening payment network, and wherein the at least one processor is further configured to:
generate an intermediate sanction score for each of one or more sanctioned entity lists, the one or more sanctioned entity lists stored in the memory device and each including information identifying one or more entities with whom payment transactions are prohibited by law;
assign the intermediate sanction score to each of the one or more sanctioned entity lists;
receive from an originating institution computing device registered with the screening payment network as an acquiring bank, an authorization request message formatted according the proprietary communications standard, the authorization request message including money transfer data including a payor's identifying information, a payment amount, and a payee account identifier;
route the authorization request message to a screening module executed by the at least one processor;
instruct the screening module to:
determine a sanction score associated with the authorization request message, the sanction score based at least in part on i) the intermediate sanction score assigned to the one or more sanctioned entity lists and ii) the money transfer data;
modify the authorization request message by inserting the sanction score into the authorization request message; and
transmit the modified authorization request message including the sanction score to a receiving institution, wherein the receiving institution is registered with the screening payment network as an issuer of a payee account associated with the payee account identifier;
receive, in real-time by in response to transmitting the modified authorization request message, an authorization response message from the receiving institution, the authorization response message formatted according to the proprietary communications standard and indicating whether the receiving institution authorizes or denies transfer of the payment amount to the payee account based on the sanction score and an existence of the payee account in good standing at the receiving institution; and
transmit the authorization response message to the originating institution.

33. The screening payment network of claim 32 further configured to compare the sanction score with at least one predefined threshold range set by one of the receiving institution and the originating institution.

34. The screening payment network of claim 33 further configured to process a plurality of money transfer transactions and generating a report of a plurality of suspicious money transfers transactions having sanction scores within the predefined threshold range.

35. The screening payment network of claim 34, wherein the report includes at least one of the payor's identifying information, potential matches with the one or more sanctioned entity lists, and the corresponding one or more sanctioned entity lists used to determine the sanction score, for each of the plurality of suspicious money transfers.

36. The screening payment network of claim 32 further configured to:
generate a plurality of intermediate sanction scores by comparing the payor's identifying information with a first set of sanctioned entity lists associated with a country's payor, a second set of sanctioned entity lists associated with a country of the originating institution, and a third set of sanctioned entity lists associated with a country of the receiving institution; and
select the highest intermediate sanction score as the sanction score.

37. The screening payment network of claim 32, wherein the request to transfer funds occurs before, or substantially simultaneously with, determining a sanction score.

38. The screening payment network of claim 32, wherein the payor's identifying information includes at least a payor name, a payor address, and a payor's date-of-birth.

39. A non-transitory computer-readable storage media having computer-executable instructions embodied thereon for real-time screening of a money transfer over a screening payment network, wherein when executed by at least one processor of a computing device, the computer-executable instructions cause the at least one processor to:
generate an intermediate sanction score for each of one or more sanctioned entity lists, the one or more sanctioned entity lists stored in a memory device and each including information identifying one or more entities with whom payment transactions are prohibited by law;
assign the intermediate sanction score to each of the one or more sanctioned entity lists;
receive from an originating institution computing device registered with the screening payment network as an acquiring bank, an authorization request message formatted according a proprietary communications standard promulgated by the screening payment network, the authorization request message including money transfer data including a payor's identifying information, a payment amount, and a payee account identifier;
route the authorization request message to a screening module executed by the at least one processor;
instruct the screening module to:
determine a sanction score associated with the authorization request message, the sanction score based at least in part on i) the intermediate sanction score assigned to the one or more sanctioned entity lists and ii) the money transfer data;
modify the authorization request message by inserting the sanction score into the authorization request message; and
transmit the modified authorization request message including the sanction score to a receiving institution, wherein the receiving institution is registered with the screening payment network as an issuer of a payee account associated with the payee account identifier;
receive, in real-time by in response to transmitting the modified authorization request message, an authorization response message from the receiving institution, the authorization response message formatted according to the proprietary communications standard and indicating whether the receiving institution authorizes or denies transfer of the payment amount to the payee account based on the sanction score and an existence of the payee account in good standing at the receiving institution; and
transmit the authorization response message to the originating institution.

40. The non-transitory computer-readable storage media of claim 39, wherein the computer-executable instructions further cause the at least one processor to compare the sanction score with at least one predefined threshold range set by one of the receiving institution and the originating institution.

41. The non-transitory computer-readable storage media of claim 40, wherein the computer-executable instructions further cause the at least one processor to process a plurality of money transfer transactions and generating a report of a plurality of suspicious money transfers transactions having sanction scores within the predefined threshold range.

42. The non-transitory computer-readable storage media of claim 41, wherein the report includes at least one of the payor's identifying information, potential matches with the one or more sanctioned entity lists, and the corresponding one or more sanctioned entity lists used to determine the sanction score, for each of the plurality of suspicious money transfers.

43. The non-transitory computer-readable storage media of claim 39, wherein the computer-executable instructions further cause the at least one processor to:
generate a plurality of intermediate sanction scores by comparing the payor's identifying information with a first set of sanctioned entity lists associated with a country's payor, a second set of sanctioned entity lists associated with a country of the originating institution, and a third set of sanctioned entity lists associated with a country of the receiving institution; and
select the highest intermediate sanction score as the sanction score.

44. The non-transitory computer-readable storage media of claim 39, wherein the request to transfer funds occurs before, or substantially simultaneously with, determining a sanction score.
